(19) United States
(12) Patent Application Publication
(10) Pub. No.: US 2011/0089194 A1
(43) Pub. Date: Apr. 21, 2011

(54) CONTAINER FOR DRINKS, IN PARTICULAR WINE, OF THE "BAG IN BOX " TYPE

(75) Inventor: Giorgio PIZZOLO, Arcole (IT)

(73) Assignee: ENOITALIA S.P.A., San Martino Buon Albergo (Verona) (IT)

(21) Appl. No.: 12/714,226

(22) Filed: Feb. 26, 2010

(30) Foreign Application Priority Data
Oct. 15, 2009 (EP) 09425408.3

(51) Int. Cl. B65D 35/56; B67D 7/06; B65D 88/54; B05B 11/00

(52) U.S. Cl. 222/105; 222/183; 222/333; 222/385

(57) ABSTRACT

A container (1) for drinks, in particular wine, of the “Bag in Box” type, comprises a rigid containment body (2) having a supporting base (3) identifying a supporting surface, a top (4) which is distanced from the supporting base (3) and an inner housing. Inserted in the inner housing there is a bag (8) designed to contain a drink. The container (1) is also equipped with a dispenser element (9) mainly extending between a drink infeed end (10) connected to the bag (8), and a dispensing nozzle (11) extending, during operation, outside the containment body (2). The dispensing nozzle (11) is vertically distanced from the supporting surface in such a way that a glass can be inserted between the dispensing nozzle (11) and the supporting surface; the container also comprises an actuator (27) for bringing the drink from the bag (8) to the dispenser element (9).

### BACKGROUND OF THE INVENTION

This invention relates to a container for drinks, in particular wine, of the “Bag in Box” type. “Bag in Box” type containers for drinks normally comprise a rigid containment body having an inner housing, and extend between a supporting base and a top which is distanced from the supporting base. The rigid containment body is normally a box having a prismatic shape. Inside the inner housing there is usually a bag, made of impermeable material, which contains the drink.

Normally, close to the containment body supporting base there is a dispenser element (usually a tap) in communication with the bag and able to dispense the drink, bringing it out of the containment body. During use of a prior art “Bag in Box”, the containment body is supported (at its own supporting base) on a supporting surface which is raised off the ground (for example a table, a shelf, etc.) and in particular at one of its edges so that the tap projects cantilever-style. In this way, by placing a glass under the tap (that is to say, in a position lower than the supporting surface) and opening the tap, it is possible to dispense into the glass part of the drink contained in the containment body. Then, by closing the tap it is possible to stop dispensing the drink when required.

The bag is normally flexible and deforms (thanks to the external air pressure) during drink dispensing, compensating for the volume of drink dispensed. However, this prior art technology has several disadvantages. First, while dispensing the drink the glass must be in a position which is lower than the container. This requires the presence of a supporting surface which is raised off the ground or relative to a reference base. For example, it would not be possible to dispense the drink if the container were supported at the centre of a table or if it were on the floor (unless it were lifted up).

Second, the tap is positioned on the container a short distance from the supporting base. In this way, when the level of drink inside the container falls below the position of the tap, the volume of liquid present between the tap and the supporting base (residual drink) is no longer dispensable. Therefore, in most cases, the supporting base must be angled relative to the supporting surface so that the residual drink descends towards the tap and so can be dispensed.

### SUMMARY OF THE INVENTION

In this situation the technical purpose which forms the basis of this invention is to provide container for drinks, in particular wine, of the “Bag in Box” type which overcomes the above-mentioned disadvantages.

In particular, the technical purpose of this invention is to provide a “Bag in Box” type container which allows the drink to be dispensed irrespective of the place where the container is positioned.

This invention also has for a technical purpose to provide a “Bag in Box” type container which guarantees dispensing of all of the drink, avoiding residues at the supporting base.

The technical purpose specified and the aims indicated are substantially achieved by a “Bag in Box” type container as described in the appended claims.

### BRIEF DESCRIPTION OF THE DRAWINGS

Further features and the advantages of this invention are more apparent in the detailed description of a preferred, non-limiting embodiment of a “Bag in Box” type container illustrated in the accompanying drawings, in which:

FIG. 1 is an axonometric view of the container for drinks, in particular wine, of the “Bag in Box” type according to this invention in which the nozzle is in a folded away position;

FIG. 2 is an axonometric view of the container for drinks of FIG. 1 in which the nozzle is in a projecting position;

FIG. 3 is an axonometric view of the container for drinks of FIG. 1 in which the nozzle is in a projecting position and the plunger is in an operating position;

FIG. 4 is an axonometric view of an inner portion of the container for drinks which is partly visible in the previous figures;

FIG. 5 is an exploded axonometric view of the portion of the container for drinks illustrated in FIG. 4;

FIG. 6 is a top view of the portion of the container for drinks illustrated in FIG. 4 without the bag;

FIG. 7 is a bottom view of the portion of the container for drinks illustrated in FIG. 4 without the bag;

FIG. 8 is a cross-section according to the line VIII-VIII of the container for drinks illustrated in FIG. 6; and

FIG. 9 is a detail of the cross-section of the container for drinks illustrated in FIG. 8.

### DETAILED DESCRIPTION OF THE INVENTION

With reference to the accompanying drawings the numeral 1 denotes as a whole a container for drinks, in particular wine, of the “Bag in Box” type made in accordance with this invention.

The container 1 for drinks according to this invention comprises a rigid containment body 2 having a supporting base 3 identifying a supporting surface, a top 4 which is distanced from the supporting base 3 and an inner housing. In the preferred embodiments the containment body 2 is a prism which, in practice, has a lower base 5 and an upper base 6 which are rectangular (corresponding to the supporting base 3 and the top 4) and rectangular lateral faces 7 (connecting the bases). In the accompanying drawings, in particular, the containment body 2 is a hollow parallelepiped.

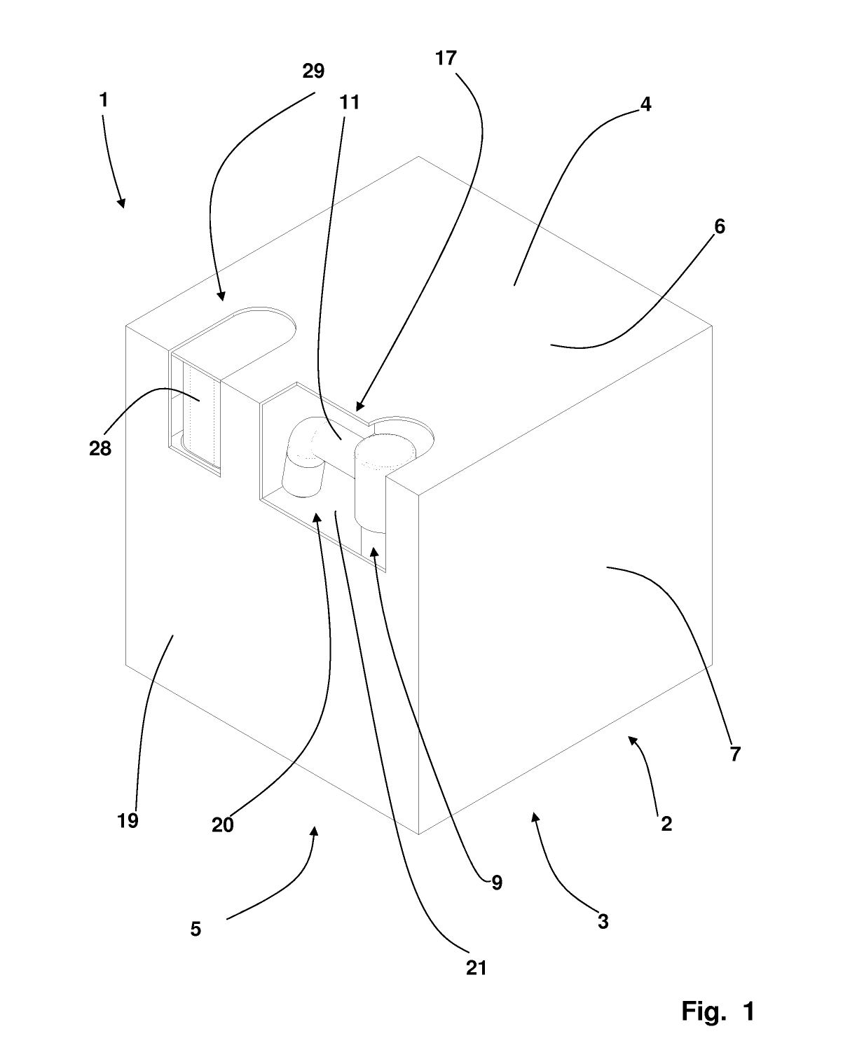

Inserted in the containment body 2 inner housing there is a bag 8 designed to contain a drink, in particular wine. The container 1 also comprises a dispenser element 9 mainly extending between a drink infeed end 10 connected to the bag 8, and a dispensing nozzle 11 extending, at least during operation, outside the containment body 2. In the preferred embodiment the dispenser element 9 is at least mainly mounted in the containment body 2 inner housing, and comprises a main body 12 whose inside forms a main duct 13 and is formed by a main duct 13 for conveying the drink to be dispensed. The main body 12 also comprises a connecting portion 14 on which the dispending nozzle 11 is rotatably mounted. The inside of the dispensing nozzle 11 also comprises a transit duct 15 which acts as a continuation of the main duct 13 (when the dispensing nozzle 11 is mounted). In particular, in the preferred embodiment the main duct 13 and the transit duct 15 both have a circular cross-section. FIG. 1 shows how, at the connecting portion 14, the dispensing nozzle 11 comprises a widened portion 16 which is mounted in a snap-on fashion on the connecting portion 14. With the snap-on mounting, between the widened portion 16 and the connecting portion 14 there are sealing means which guarantee isolation from the air.

According to what was already said, the dispensing nozzle 11 is therefore able to rotate (in a horizontal plane passing through the dispensing nozzle 11) between a folded away position 17 in which it is closest to the containment body 2 and is within the dimensions of the containment body 2, and a projecting position 18 in which it projects outwards. In other embodiments, not illustrated, the nozzle 11 may be able to move by sliding between a position in which it is inside the containment body 2 and a position in which it slides outwards.

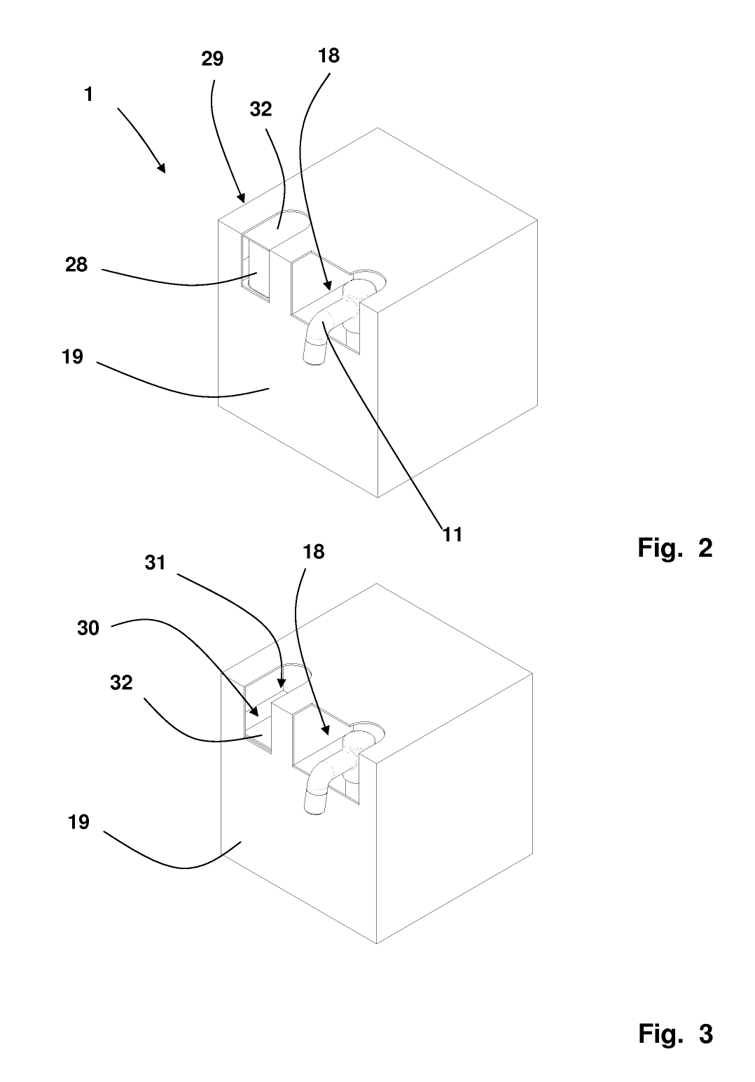

According to this invention, the dispensing nozzle 11 is vertically distanced from the supporting surface in such a way that a glass may be inserted between the nozzle 11 and the supporting surface. Therefore, the dispensing nozzle 11 may be positioned on a lateral face 7 of the containment body 2, or on the top 4 of the containment body 2. In the embodiment illustrated in FIG. 1 the outside of the containment body 2, on part of a lateral face 7 (hereinafter called the dispensing face 19) closest to the top 4 comprises a dispensing housing 20 in which a dispensing base 21 is formed which is substantially parallel with the supporting surface and perpendicular to the dispensing face 19. The dispensing base 21 advantageously comprises a first hole in which the connecting portion 14 of the main body 12 passes from the inner housing to the dispensing housing 20. The dispensing nozzle 11 in the folded away position 17 is inserted in the dispensing housing 20 and is therefore within the dimensions of the containment body 2 (FIG. 1). In contrast, when the dispensing nozzle 11 is in the projecting position 18 it at least partly extends cantilever-style outwards from the dispensing housing 20 (FIG. 2). In the embodiment illustrated in the accompanying drawings, the nozzle 11 extends from the connecting portion 14 to its own dispensing end 22, from which the drink comes out. Advantageously, the dispensing end 22 may project from the dispensing face 19 enough to project towards the zone containing a glass placed under the dispensing nozzle 11 and close to the containment body 2.

At the dispensing end 22, the dispensing nozzle 11 comprises delivery valve means 23. These delivery valve means 23 are equipped with a moving element which moves between a first, dispensing condition, during which the drink may be dispensed, and a second, stop condition, during which drink dispensing is stopped.

In particular, the delivery valve means 23 are a ball valve formed by a narrowing element 24 inserted in the dispensing nozzle 11 close to the dispensing end 22. The narrowing element 24 narrows the cross-section of the transit duct 15. The ball valve also comprises a ball 25 whose diameter is greater than that formed by the narrowing element 24 and in contact with it. Moreover, a contact spring 26 (also part of the ball valve) is in contact with the ball 25 and is connected to the dispensing end 22. In this way, following the drink dispensing direction, the ball 25 is downstream of the narrowing element 24, whilst the contact spring 26 is downstream of the ball 25 and makes contact with the dispensing end 22.

In this way, in the stop condition, the ball 25 is kept so that it is resting against the narrowing element 24, whilst when the pressure in the transit duct 15 increases (due to the arrival of the drink towards the dispensing nozzle 11), the ball 25 is pushed towards the contact spring 26 (creating a passage between the ball 25 and the narrowing element 24), causing the delivery valve means 23 to open and thus pass to the dispensing condition. When dispensing is complete, the contact spring 26 again pushes the ball 25 against the narrowing element 24, closing the passage for the drink.

According to this invention, the container 1 also comprises pumping means 27 designed to bring the drink from the bag 8 to the infeed end 10 of the dispenser element 9. The pumping means 27 are advantageously inserted in the containment body 2 (in such a way that they do not interfere with the outer dimensions of the containment body 2).

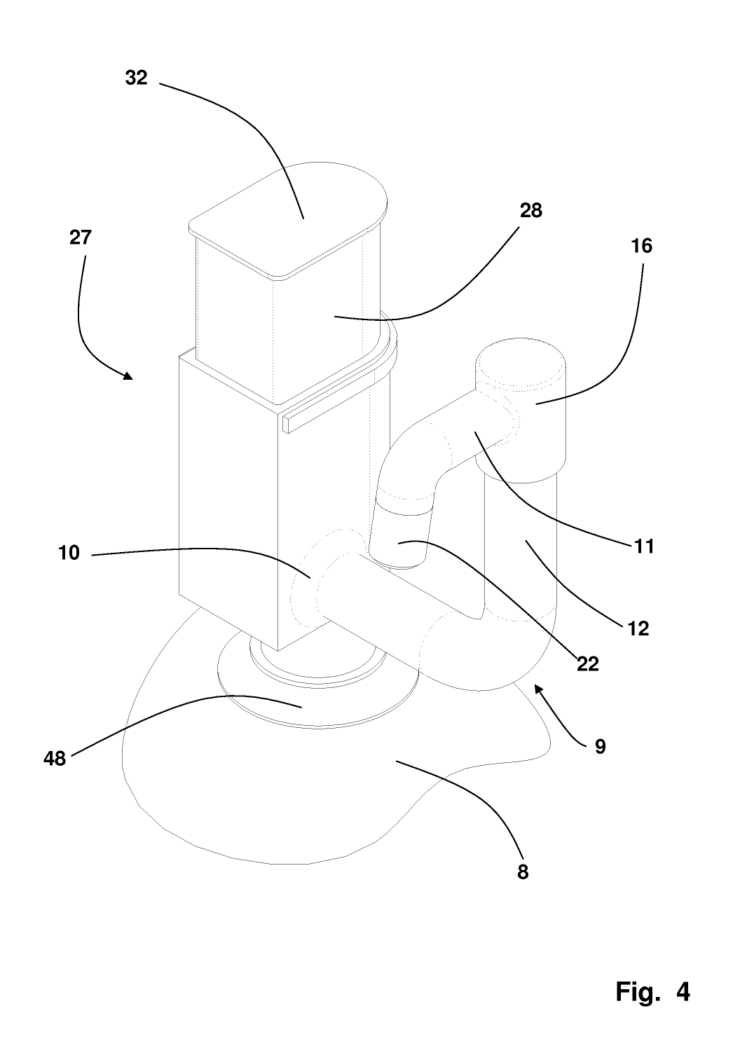

In the preferred embodiment, the pumping means 27 comprise a manual actuator. In the embodiment illustrated in the accompanying drawings, the pumping means 27 comprise a plunger 28 mounted on the containment body 2 and accessible from outside the containment body 2. The plunger 28 can move between a home position 29 and an operating position 30, in such a way that during the movement from the home position 29 to the operating position the drink is dispensed. In other embodiments, not illustrated, it is possible that the movement which causes the drink to be dispensed is given by the plunger 28 passing from the operating position 30 to the home position. Or dispensing may occur both during the plunger 28 movement from the operating position 30 to the home position 29 and vice versa. In the embodiment illustrated in FIG. 1, the plunger 28 is accessible close to the top 4 of the rigid containment body 2 and can be operated with a vertical movement from the top 4 towards the supporting base 3. In particular, in the embodiment of FIG. 1 the containment body 2 comprises an opening 31 in the dispensing face 19 and close to the top 4 which also extends in the top 4. In the preferred embodiment, the plunger 28 comprises an operating surface 32 parallel with the supporting base 3. When the plunger 28 is in the home position 29 (FIG. 1) the operating surface 32 forms a continuation of the upper base 6, but does not extend outside the dimensions of the containment body 2. In FIG. 3 the plunger 28 is shown in the operating position 30. In this case, the operating surface 32 is distanced from the top 4.

The pumping means 27 also comprise a chamber 33 inserted in the inner housing in which the plunger 28 is slidably inserted in a sealed fashion. At least most of the plunger 28 is inserted in the chamber 33 in the operating position 30. In the home position 29 only part of the plunger is inserted in the chamber 33.

The chamber 33 is formed by the inner surface of a jacket 34, the inner surface in practice being in contact in a sealed fashion with the plunger 28. The part of the plunger 28 facing towards the jacket 34 comprises a cavity 35 which together with the chamber 33 forms an operating space 36 in communication with the bag 8. Therefore, when the plunger 28 is in the home position 29 the operating space 36 is at its maximum and is formed by the cavity 35 and by the chamber 33, whilst when the plunger 28 is in the operating position 30 the operating space 36 is at its minimum and is formed only by the space inside the plunger 28.

Elastic means 37 are also connected to the plunger 28, for returning it from the operating position 30 to the home position. In the preferred embodiment the elastic means 37 comprise a spring 38 inserted in the operating space 36 between the chamber 33 and the cavity 35, and which is extended when the plunger 28 is in the home position 29, but compressed when the plunger 28 is in the operating position 30.

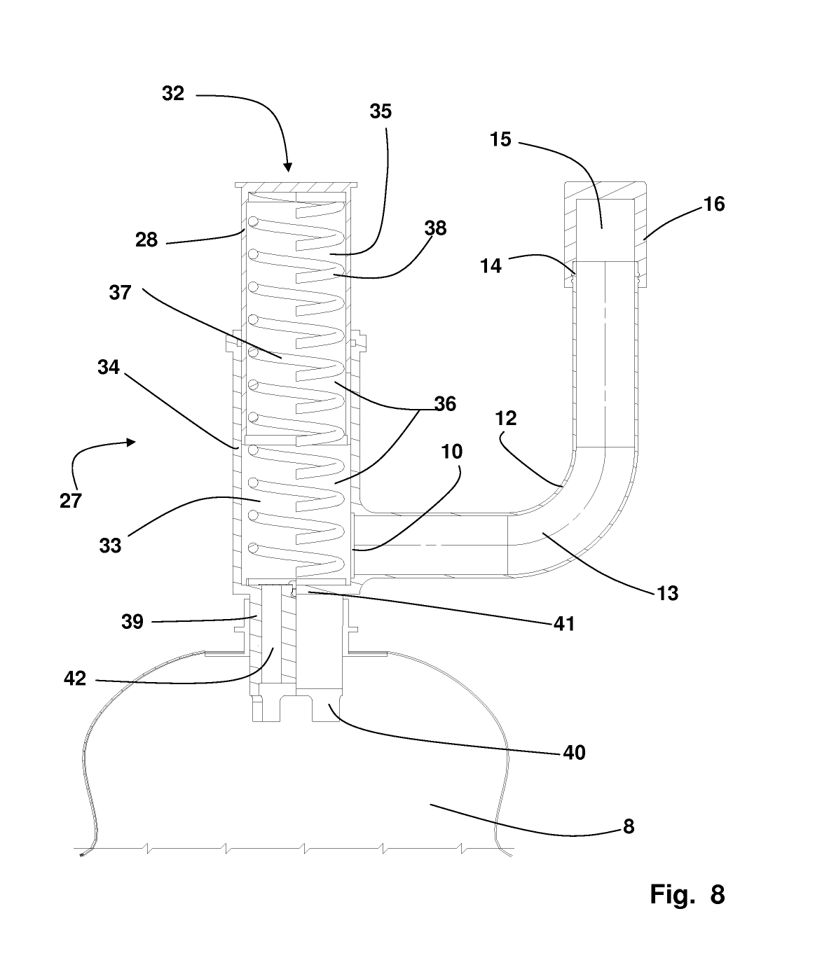

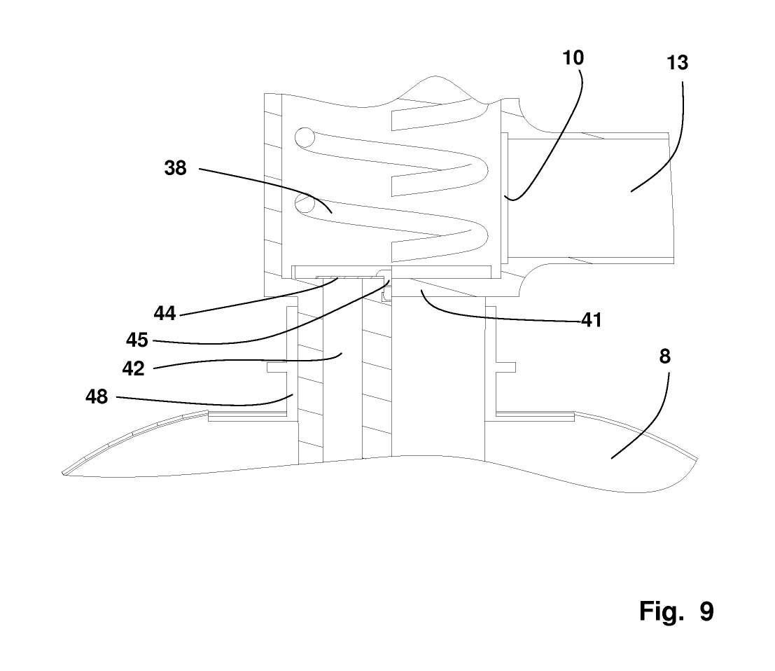

The chamber 33 is also in communication with the main duct 13. As FIG. 8 shows, the infeed end 10 of the dispenser element 9 is connected to the chamber 33. At the same time, the chamber 33 is selectively in communication with the bag 8. In the preferred embodiment the jacket 34 comprises a connecting pin 39 for connecting the chamber 33 to the bag 8. The pin 39 extends between a first end 40, in practice inserted in the bag 8, and a second end 41, connected to the chamber 33. Advantageously, the inside of the pin 39 comprises four through-holes 42 extending from the first end 40 to the second end 41 for putting the bag 8 into communication with the chamber 33. In the preferred embodiment, the pin 39 has a circular cross-section and the holes 42 are distributed in it.

Interposed between the chamber 33 and the bag 8 there are suction valve means 43 equipped with a moving element which moves between a first, open condition, in which it puts the bag 8 into communication with the chamber 33, and a second, closed condition, in which it stops communication between the chamber 33 and the bag 8.

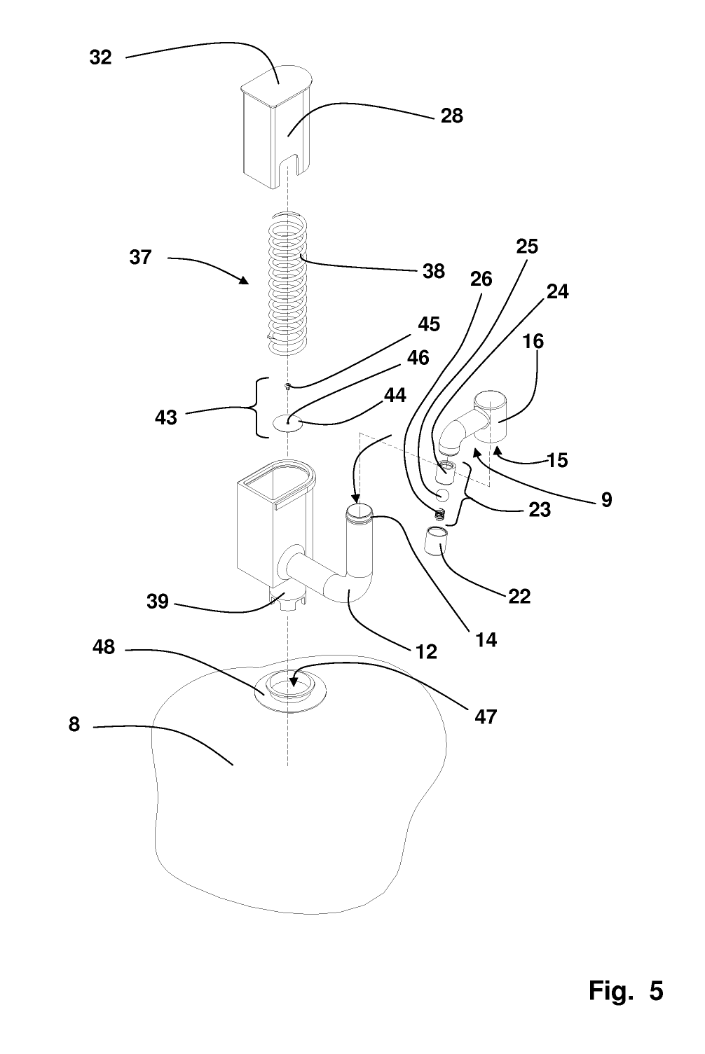

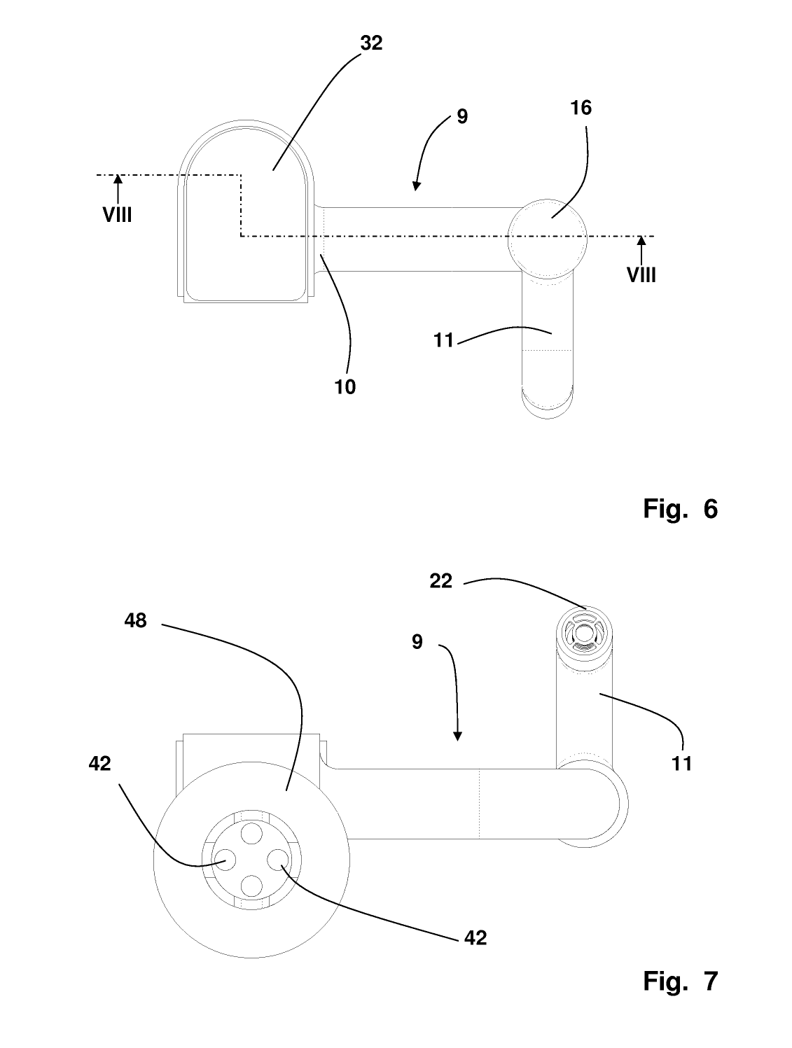

In the preferred embodiment illustrated in the exploded drawing in FIG. 5, the suction valve means 43 are a diaphragm valve comprising a flexible diaphragm 44 and a stop element 45. The diaphragm 44 advantageously has the shape of a disk and is positioned in the chamber 33 on the second end 41 of the pin 39. The stop element 45 is inserted in the diaphragm 44 (at a hole 46 made in the centre of it) and is fastened on the pin 39 at the centre of the four through-holes 42. Advantageously, the diaphragm 44 is fastened to the pin 39 and covers the through-holes 42. However, the diaphragm 44, being fastened only at its central part, is deformable along its edge, allowing the drink to pass from the bag 8 to the chamber 33 as the plunger 28 passes from the operating position 30 to the home position (as explained in more detail below).

In an alternative embodiment, not illustrated in the accompanying drawings, the pumping means 27 may comprise a pump driven by an electric unit and which can be controlled by an operator using a switch accessible from outside the containment body 2. In this case, the electric unit comprises a power supply battery which may preferably have a predetermined autonomy based on the average life of a container 1 of this type or the length of time for which the drink contained in it can be kept.

In the preferred embodiment, illustrated in the accompanying drawings, the bag forms a mouth 47 at which its inside can be accessed. The mouth 47 is surrounded by a connecting ring 48 in which the pin 39 is inserted for a sealed connection.

The container 1 for drinks according to this invention is used to contain any type of drink, but preferably to contain wine. The containment body 2 is preferably made of cardboard and, in the preferred embodiment, is a box. Advantageously, the container 1 according to this invention may be made of recyclable and/or biodegradable materials.

Operation of the container 1 for drinks according to this invention derives directly from what is described above. In particular, the bag 8 contains a drink (for example wine) and the container 1 rests on a supporting surface (at its supporting base 3). In this way, an external operator can manually act on the dispensing nozzle 11, moving it from the folded away position 17 to the dispensing position, thus making the dispensing end 22 project from the containment body 2 above a glass which is placed on the supporting surface.

Therefore, a user can dispense the drink by applying (preferably with one finger) the necessary pressure on the operating surface 32 of the plunger 28, thus moving the plunger from the home position 29 to the operating position 30.

When dispensing is complete and the user wants to put away the container 1, the dispensing nozzle 11 can be rotated so that it returns to its folded away position 17.

This invention brings important advantages. First, it allows the drink to be dispensed irrespective of the place where the container is positioned. The nozzle is positioned on the container in a position which allows the container and the glass to lie on the same supporting surface.

Moreover, thanks to the action of the pumping means, the container guarantees dispensing of all of the drink, avoiding residues in the bag at the supporting base.

It should also be noticed that this invention is relatively easy to produce and that even the cost linked to implementing the invention is not very high.

The invention described above may be modified and adapted in several ways without thereby departing from the scope of the inventive concept.

Moreover, all details of the invention may be substituted with other technically equivalent elements and in practice all of the materials used, as well as the shapes and dimensions of the various components, may vary according to requirements.

What is claimed is

1) A container for drinks, in particular wine, of the “Bag in Box” type comprising: a rigid containment body having a supporting base identifying a supporting surface, a top which is distanced from the supporting base and an inner housing; a bag designed to contain a drink inserted in the inner housing; the container being equipped with a dispenser element mainly extending between a drink infeed end connected to the bag and a dispensing nozzle extending outside the containment body during operation; wherein the dispensing nozzle is vertically distanced from the supporting surface in such a way that a glass can be inserted between the dispensing nozzle and the supporting surface, the container further comprising pumping means for bringing the drink from the bag to the dispenser element.

2) The container for drinks according to claim 1, wherein the pumping means is manually operated.

3) The container for drinks according to claim 2, wherein the pumping means comprises a plunger mounted on the containment body and accessible from outside the latter; the plunger being movable between a home position and an operating position, the movement from the home position to the operating position and/or vice versa causing the drink to be dispensed.

4) The container for drinks according to claim 3, wherein the plunger is accessible close to the top of the rigid containment body and is manually operated to bring it from the home position to the operating position.

5) The container for drinks according to claim 3 wherein the pumping means comprises a chamber inserted in the inner housing in which the plunger is slidably inserted in a sealed fashion; at least most of the plunger being inserted in the chamber in the operating position, and the plunger only partly being inserted in the chamber in the home position.

6) The container for drinks according to claim 5, wherein elastic means is connected to the plunger, for returning it from the operating position to the home position.

7) The container for drinks according to claim 5, wherein the dispenser element is in communication with the chamber; the chamber being selectively in communication with the bag.

8) The container for drinks according to claim 7, wherein suction valve means is interposed between the chamber and the bag; said suction valve means being equipped with a moving element which moves between a first, open condition, in which it puts the bag into communication with the chamber, and a second condition, in which it stops communication between the chamber and the bag.

9) The container for drinks according to claim 8, wherein the suction valve means is a diaphragm valve.

10) The container for drinks according to claim 1, wherein the pumping means comprises a pump driven by an electric unit which an operator can control using a switch accessible from outside the containment body; the electric unit comprising a power supply battery.

11) The container for drinks according to claim 1, comprising delivery valve means at the dispensing nozzle; said delivery valve means being equipped with a moving element which moves between a first, dispensing condition for dispensing the drink, and a second, stop condition for stopping drink dispensing.

12) The container for drinks according to claim 11, wherein the delivery valve means is a ball valve.

13) The container for drinks according to claim 1, wherein the dispensing nozzle is movable, preferably by rotating, between a folded away position in which it is closest to the containment body and a projecting position in which it projects outwards.

14) The container for drinks according to claim 1, wherein in the folded away position the dispensing nozzle is within the dimensions of the containment body.

15) The container for drinks according to claim 1, wherein the bag contains wine.
